(19) United States
(12) Patent Application Publication
(10) Pub. No.: US 2006/0111053 A1
(43) Pub. Date: May 25, 2006

(54) RFID system using mobile phone as device of access control and security response

(75) Inventors: Bo-Chen Wu, Tainan City (TW); Pei-Fang Liang, Beigang Town (TW); Ming-Hsiu Hsu, Nantou City (TW); Wu-Chi Ho, Hsinchu City (TW)

Correspondence Address: BRUCE H. TROXELL, 5205 LEESBURG PIKE, SUITE 1404, FALLS CHURCH, VA, 22041, US

(73) Assignee: Industrial Technology Research Institute

(21) Appl. No.: 11/041,946

(22) Filed: Jan. 26, 2005

(30) Foreign Application Priority Data
Nov. 23, 2004 (TW) 93135941

(51) Int. Cl. H04B 1/38; H04M 1/00

(52) U.S. Cl. 455/90.3; 455/550.1; 455/556.1

(57) ABSTRACT

The present invention discloses a RFID system using mobile phone as a device of access control and security response, comprising: a mobile phone, having a RFID tag disposed therein; a RFID transponder, capable of activating the RFID tag for enabling the mobile phone to issue a message while detecting the RFID-tagged mobile phone; and a wireless communication system, capable of informing the message to a specific person through an networking interface while receiving the message sent by the RFID-tagged mobile phone.

### 1. FIELD OF THE INVENTION

The present invention relates to a radio frequency identification (RFID) system using mobile phone as device of access control and security response, and more particularly, to a RFID system capable of using a mobile phone having a RFID tag arranged therein to issue a short message to a specific system or a specific personnel while the RFID tag is sensed and activated by a RFID transponder of a specific area as the user of the mobile phone enters the specific area so as to accomplish operations of access control, security response, etc.

### 2. BACKGROUND OF THE INVENTION

Recently, there is a growing concern on the personal safety of school kids, not only in campus, and particularly while traveling to the school. Since most parents rely on public transportation to carry their children to school, the worry that kids might meet a certain dangers, even be kidnapped, during the trip to school motivates parents to use various means for ensuring the safety of their children.

There is already a RFID security system for ensuring the safety of school children. The conventional RFID system provides a RFID-tagged ID card for each school kid while installing a RFID transponder either at the entrance of the campus or the classroom, such that the RFID transponder will automatically scan the information of the RFID-tagged ID card for enabling the personal data of the kid corresponding to the ID cad to be converted into an electronic data, and then the electronic data is processed by the campus server for enabling a cooperated telecommunication provider to issue a short message to inform the kid's parents of the time of arrival/leaving of their kid. Nevertheless, the conventional RFID system still has shortcomings as following:
(1) Peer pressure might reduce the will of a school kid to wear the RFID-tagged ID card since he is afraid of being laughed at for wearing a nerdy card.
(2) For the conventional RFID security system to perform, it is necessary to require a school kid to take out the RFID-tagged ID card for the RFID transponder to scan each time when he/her is entering or exiting the campus or class room that is almost impossible to ask the kid to follow the rule at each entering and exiting.
(3) The computer server and RFID transponders of the conventional RFID security system require to be maintained by specific personnel hired by the school or sent by the cooperated telecommunication provider, that, in either case, will increase cost.

From the above description, it is clear that there is a need for an improved RFID security system capable of satisfying the safety concern of parents on their children while traveling to school.

### SUMMARY OF THE INVENTION

It is the primary object of the invention to provide a RFID system capable of using a mobile phone having a RFID tag arranged therein to issue a short message to a specific system or a specific personnel while the RFID tag is sensed and activated by a RFID transponder of a specific area as the user of the mobile phone enters the specific area so as to accomplish operations of access control, security response, etc.

It is another object of the invention to provide a RFID-tagged mobile phone for replacing the RFID-tagged ID card of the prior arts, such that the peer pressure against the RFID system is avoid since the mobile phone is considered to be a fashion product to carry and is not required to be taken out for scanning.

Yet, another object of the invention is to provide a RFID system operating cooperatively with the wireless network provided by a telecommunication company for transmitting a short message to a specific person, so that the RFID system of the invention can be maintain with only a few cost pay to the telecommunication company.

Objectives, advantages and applications of the present invention will be made apparent by the following drawings, detailed description of the invention.

### BRIEF DESCRIPTION OF THE DRAWINGS

FIG. 1 is a function block diagram showing a RFID system using mobile phone as device of access control and security response according to the present invention.

FIG. 2A is a schematic representation showing that a RFID tag is disposed on the subscriber identity module (SIM) card of a mobile phone according to the present invention.

FIG. 2B is a schematic representation showing that a RFID tag is disposed on the printed circuit board (PCB) of a mobile phone according to the present invention.

FIG. 2C is a schematic representation showing that a RFID tag is disposed on the back cover of a mobile phone according to the present invention.

FIG. 2D is a schematic representation showing that a RFID tag is disposed on the battery of a mobile phone according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

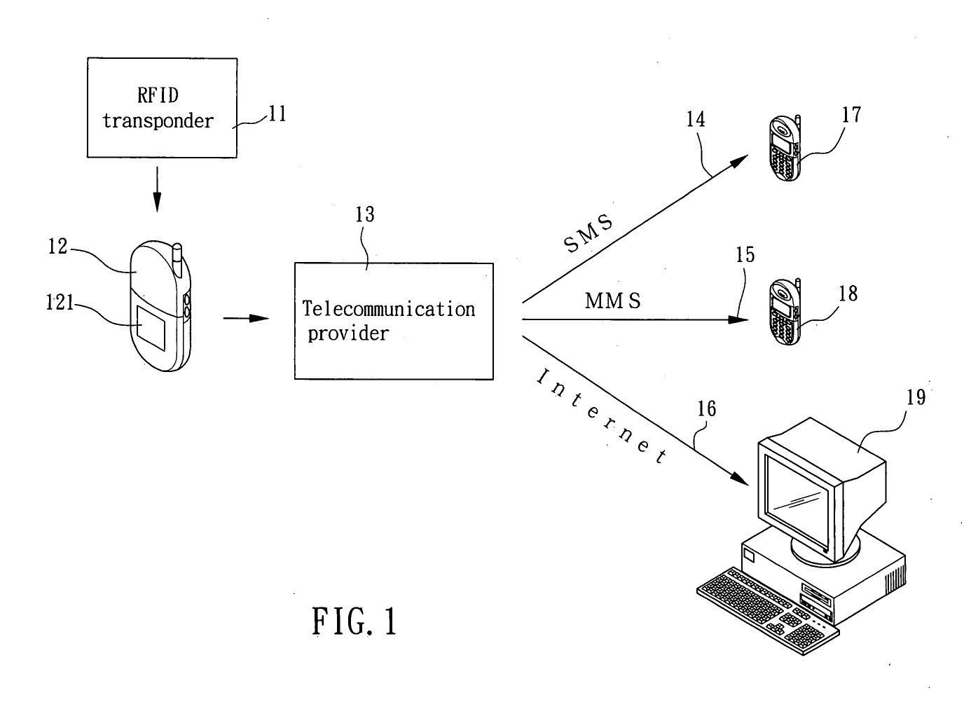

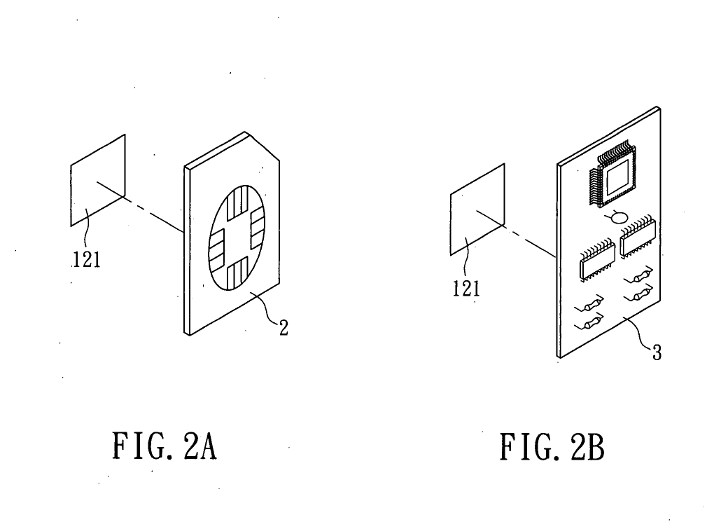

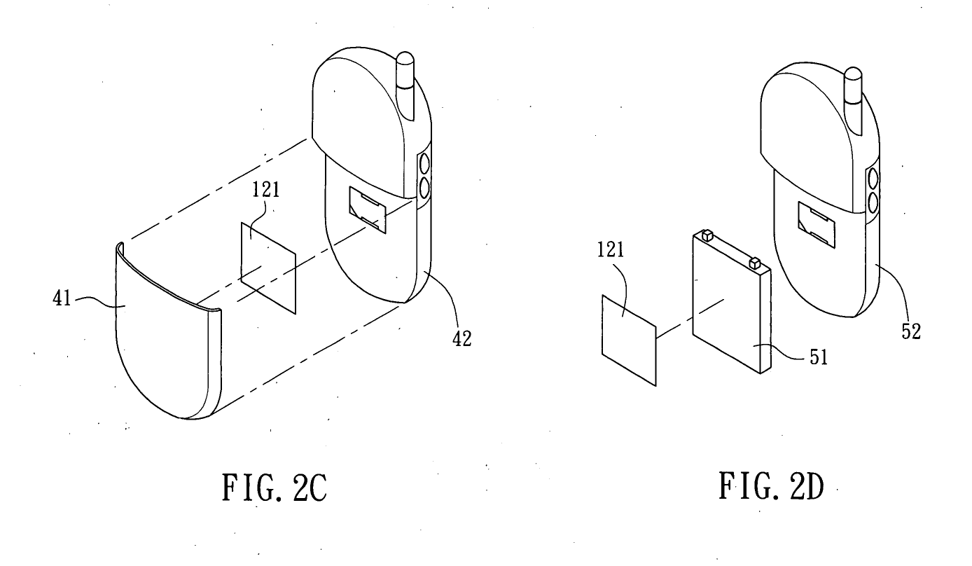

Please refer to FIG. 1, which is a function block diagram showing a RFID system using mobile phone as device of access control and security response according to the present invention. As seen in FIG. 1, a RFID transponder 11 capable of detecting any device having a RFID tag 121 arranged therein is disposed at an entrance of a classroom or a campus, in which the RFID-tagged device a mobile phone 12. Since the RFID tag 121 is small-sized and light-weighted, it can be arranged in any component of the mobile phone, such as a subscriber identity module (SIM) card, a printed circuit board, an external memory card, a display, a battery, and so on. In addition, as to the position for disposing of the RFID tag, there is no specific restriction. Please refer to FIGS. 2A, 2B, 2C and 2D for several embodiments of the disposition of RFID tag in the mobile phone 12, which are only preferred embodiments and should not limit the range of the embodiment of the present invention.

Assuming the person carrying the mobile phone 12 is a school kid and as the school kid enters a classroom or campus while carrying the mobile phone 12, the RFID tag 121 arranged inside the mobile phone 12 will be detected and activated to enable the mobile to issue a predefined message to a telecommunication provider 13, and thereafter the telecommunication provider 13 will broadcast the message through the networking interface provided by its wireless communication system to the mobile phones 18, 19 and server 19 for informing the parents of the school kid or a campus management personnel that the school kid carrying the mobile phone 12 has already entered the specific area guarded by the RFID transponder 11 so as to accomplish operations of access control, security response, etc. Moreover, the networking interface used by the telecommunication provide 13 can be one selected from the group consisting of the Wireless Application Protocol, the General Packet Radio Service, the Personal Handy-Phone System, the 3G mobile phone system, and the Internet, etc. Hence, the format of the message can be defined by one selected from the group consisting of E-mail, Short Message Service, Multi-media Service, and so on, wherein the multi-media service is capable of supporting messages comprising video data and audio data.

To sum up, the RFID system of the present invention has the following advantages:
(1) The invention provides a RFID-tagged mobile phone for replacing the RFID-tagged ID card of the prior arts, such that the peer pressure against the RFID system is avoid since the mobile phone is considered to be a fashion product to carry and is not required to be taken out for scanning.
(2) The invention provides a RFID system operating cooperatively with the wireless network provided by a telecommunication company for transmitting a short message to a specific person, so that the RFID system of the invention can be maintain with only a few cost pay to the telecommunication company.
(3) Since a RFID tag is arranged in a mobile according to the present invention, the battery of the mobile phone can also provide power to the RFID tag, such that the battery power enables the RFID tag to operate in active mode or semi-active mode and to send out a stronger signal than a passive RFID tags.
(4) The antenna required by the RFID tag can be integrated with the antenna of the mobile phone, such that not only the space for accommodating the RFID tag is minimized, but also the signal transmission capability of the RFID tag is improved.
(5) The usage of the RFID-tagged mobile phone is enlarged since the RFID tag arranged therein could have countless applications by combining with other wireless network.

Only the abovementioned is just the preferred embodiment of the present invention, and should not limit the range of embodiment of the present invention. Namely all changes and modification according to the claims of the present invention should still belong within the range of patent coverage of the present invention. Hereby the inventor requests sage identification and favorable granting of the examiners as the most hoped for.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A RFID system using mobile phone as a device of access control and security response, comprising:
a mobile phone, having a RFID tag disposed therein;
a RFID transponder, capable of activating the RFID tag for enabling the mobile phone to issue a message while detecting the RFID-tagged mobile phone; and
a wireless communication system, capable of informing the message to a specific person through an networking interface while receiving the message sent by the RFID-tagged mobile phone.

2. The RFID system as recited in claim 1, wherein the RFID tag is disposed in a subscriber identity module card of the mobile phone.

3. The RFID system as recited in claim 1, wherein the RFID tag is disposed in a printed circuit board of the mobile phone.

4. The RFID system as recited in claim 1, wherein the RFID tag is disposed in an external memory card of the mobile phone.

5. The RFID system as recited in claim 1, wherein the RFID tag is disposed in a display of the mobile phone.

6. The RFID system as recited in claim 1, wherein the RFID tag is disposed in a battery of the mobile phone.

7. The RFID system as recited in claim 1, wherein the RFID tag is disposed in a housing of the mobile phone.

8. The RFID system as recited in claim 1, wherein the networking interface is the Wireless Application Protocol (WAP).

9. The RFID system as recited in claim 1, wherein the networking interface is the General Packet Radio Service (GPRS).

10. The RFID system as recited in claim 1, wherein the networking interface is the Personal Handy-Phone System (PHS).

11. The RFID system as recited in claim 1, wherein the networking interface is the Third Generation (3G) mobile phone system.

12. The RFID system as recited in claim 1, wherein the networking interface is the Internet.

13. The RFID system as recited in claim 12, wherein the message sent through the Internet is an E-mail.

14. The RFID system as recited in claim 1, wherein the format of the message sent through the networking interface is defined by a short message service (SMS) of the wireless communication system.

15. The RFID system as recited in claim 1, wherein the format of the message sent through the networking interface is defined by a multi-media service (MMS) of the wireless communication system.

16. The RFID system as recited in claim 15, wherein the multi-media service supports messages comprising video data and audio data.
